(19) United States
(12) Patent Application Publication
(10) Pub. No.: US 2025/0333034 A1
(43) Pub. Date: Oct. 30, 2025

(54) BRAKING CONTROL DEVICE FOR VEHICLES

(71) Applicant: ADVICS CO., LTD., Kariya-shi, Aichi-ken (JP)

(72) Inventors: Jun SHINOZAKI, Kariya-shi, Aichi-ken (JP); Takanori IIDA, Kariya-shi, Aichi-ken (JP); Masayuki NAITO, Kariya-shi, Aichi-ken (JP)

(73) Assignee: ADVICS CO., LTD., Kariya-shi, Aichi-ken (JP)

(21) Appl. No.: 18/857,372

(22) PCT Filed: Apr. 27, 2023
(86) PCT No.: PCT/JP2023/016588

§ 371 Date: Jul. 23, 2025

(30) Foreign Application Priority Data
Apr. 27, 2022 (JP) 2022-073075
Jul. 27, 2022 (JP) 2022-119501

(51) Int. Cl. B60T 13/14; B60T 17/22

(52) U.S. Cl. CPC B60T 13/148; B60T 13/147; B60T 17/22

(57) ABSTRACT

A braking control device includes a fluid pump driven by an electric motor via a coupling part, a differential pressure valve provided in a fluid path connecting a discharge part and an intake part of the fluid pump, the differential pressure valve increasing a wheel pressure of a wheel cylinder by increasing a braking liquid discharged from the fluid pump to an output pressure, and a controller that drives the electric motor and the differential pressure valve. When a valve opening amount of the differential pressure valve is reduced in a state in which the electric motor is driven, the controller performs an appropriateness determination as to whether or not the coupling part is normal based on a change in a state quantity related to the electric motor.

### TECHNICAL FIELD

The present disclosure relates to a braking control device for vehicles.

### BACKGROUND ART

Patent Literature 1 describes that, in order to perform abnormality determination of a sensor that detects a wheel cylinder pressure while determining whether pump driving by electric motor control is normally performed by detecting the wheel cylinder pressure, a brake fluid pressure is detected by pressure sensors 16 to 20 when a brushless motor 33 is driven by a predetermined control amount, and abnormality determination of a pump unit 50 and a valve unit 51 is performed by comparing the brake fluid pressure at this time with a previously calculated liquid pressure generated when the brushless motor 33 is driven by the predetermined control amount.

In Patent Literature 1, abnormality of the brushless motor 33 and the gear pump 34 is determined based on a comparison result between a pressure estimation value estimated from a control amount of the brushless motor and a pressure detection value detected by a pressure sensor. Specifically, the determination is performed with the following process.

(1) In a state where pressure increasing valves 25 to 28 are closed, the brushless motor 33 is driven by a predetermined control amount, and the gear pump 34 sets the discharge pressure in the brake fluid piping 43 to a pressure estimation value P01.

(2) The discharge pressure (internal pressure) of the brake fluid piping 43 is detected as a pressure detection value P1 by the pressure sensor 16. Then, comparison is made with a value obtained by giving a range above and below the pressure estimation value P01 that should have been generated by the brushless motor 33 and the gear pump 34.

(3) When the condition of P01−ΔP≤P1≤P01+ΔP is satisfied, it is determined that the brushless motor 33 and the gear pump 34 sufficiently exhibit performance. When the condition of P01−ΔP≤P1≤P01+ΔP is not satisfied, it is determined that there is a possibility that an abnormality occurs in the brushless motor 33 and the gear pump 34 and the brushless motor and the gear pump do not operate normally.

In the pump unit (also referred to as an “electric pump”), the electric motor and the fluid pump are coupled by a coupling device. As described in Patent Literature 2, the applicant has developed a coupling device that connects an electric motor and a fluid pump, the coupling device having a long lifespan and capable of smoothly and quietly transmitting a rotational force. When the coupling device (also referred to as “coupling part”) is applied to the braking control device, it is desired that an abnormality of the coupling part be detected in the braking control device.

### CITATIONS LIST

### Patent Literature

Patent Literature 1: JP 2009-067335 A

Patent Literature 2: JP 2011-080530 A

### SUMMARY

### Technical Problems

An object of the present disclosure is to provide a braking control device capable of detecting an abnormality when the abnormality occurs in a coupling part connecting an electric motor and a fluid pump.

### Solutions to Problems

A braking control device (SC) for vehicles according to the present disclosure includes: a fluid pump (QA) driven by an electric motor (MA) via a coupling part (CA); a differential pressure valve (UA) that is provided in a fluid path (HK) connecting a discharge part (Qo) of the fluid pump (QA) and an intake part (Qi) of the fluid pump (QA), and increases a wheel pressure (Pw) of a wheel cylinder (CW) by increasing a braking liquid (BF) discharged from the fluid pump (QA) to an output pressure (Pq, Pu); and a controller (ECU) that drives the electric motor (MA) and the differential pressure valve (UA).

In the braking control device (SC) for vehicles according to the present disclosure, when a valve opening amount of the differential pressure valve (UA) is reduced in a state in which the electric motor (MA) is driven, the controller (ECU) performs an appropriateness determination as to whether or not the coupling part (CA) is normal based on a change in state quantity (Ma) related to the electric motor (MA).

In the braking control device (SC) for vehicles according to the present disclosure, when a valve opening amount of the differential pressure valve (UA) is reduced in a state in which a rotation number (Na) of the electric motor (MA) is controlled to be a constant rotation number (na), the controller (ECU) performs an appropriateness determination as to whether or not the coupling part (CA) is normal based on an increase in an output equivalent value (Tm) equivalent to an output of the electric motor (MA). Specifically, the controller (ECU) determines that the coupling part (CA) is normal when the output equivalent value (Tm) is greater than or equal to a determination threshold value (ix).

In the braking control device (SC) for vehicles according to the present disclosure, when a valve opening amount of the differential pressure valve (UA) is reduced in a state in which a constant current (im) is supplied to the electric motor (MA), the controller (ECU) performs an appropriateness determination as to whether or not the coupling part (CA) is normal based on a decrease in rotation number (Na) of the electric motor (MA). Alternatively, when the differential pressure valve (UA) is completely closed in a state in which the electric motor (MA) is driven, the controller (ECU) performs an appropriateness determination as to whether or not the coupling part (CA) is normal based on a decrease in rotation number (Na) of the electric motor (MA). Specifically, the controller (ECU) determines that the coupling part (CA) is normal when the rotation number (Na) is less than or equal to a determination rotation number value (nx).

The braking control device (SC) for vehicles according to the present disclosure further includes an inlet valve (VI) provided in a liquid pressure transmission path (HW) from the output pressure (Pq, Pu) to the wheel pressure (Pw), and a check valve (GA) that allows discharge of braking liquid (BF) from the fluid pump (QA) in one direction but inhibits the discharge in the other direction opposite to the one direction. The controller (ECU) drives the inlet valve (VI). When the electric motor (MA) is driven in a forward rotation direction corresponding to the one direction in a state in which the inlet valve (VI) and the differential pressure valve (UA) are closed, the controller (ECU) performs an appropriateness determination as to whether or not the coupling part (CA) is normal based on an increase in a rotation angle (Ka) of the electric motor (MA). Specifically, the controller (ECU) determines that the coupling part (CA) is abnormal when the rotation angle (Ka) is greater than or equal to a determination angle (kx) with reference to a state before the electric motor (MA) is driven in the forward rotation direction. Furthermore, the controller (ECU) preferably drives the electric motor (MA) in a reverse rotation direction opposite to the forward rotation direction before driving the electric motor (MA) in the forward rotation direction.

The electric motor MA and the fluid pump QA are connected by a coupling part CA. When the electric motor MA is driven, the braking liquid BF is discharged from the fluid pump QA, and a flow KN (circulation flow) of the braking liquid circulating in the fluid path HK is generated. The differential pressure valve UA is provided in the fluid path HK, but when the valve opening amount is reduced, the braking liquid BF becomes difficult to flow. Therefore, the load of the electric motor MA is large when the coupling part CA is normal and small when the coupling part is abnormal. According to the above configuration, the appropriateness of the coupling part CA is suitably determined based on the change in the state quantity (e.g., the output equivalent value Tm, the motor rotation number Na, and the motor rotation angle Ka) related to the electric motor MA.

### BRIEF DESCRIPTION OF DRAWINGS

FIG. 1 is a schematic view for describing a first embodiment of a braking control device SC.

FIG. 2 is a block diagram for explaining an outline of appropriateness determination of a coupling part CA.

FIGS. 3A and 3B are time-series diagrams for explaining a first processing example of appropriateness determination.

FIGS. 4A and 4B are time-series diagrams for explaining a second processing example of appropriateness determination.

FIGS. 5A and 5B are time-series diagrams for explaining a third processing example of appropriateness determination.

FIGS. 6A and 6B are time-series diagrams for explaining a fourth processing example of appropriateness determination.

FIG. 7 is a schematic view for describing a second embodiment of a braking control device SC.

FIG. 8 is a schematic view for describing a third embodiment of a braking control device SC.

### DESCRIPTION OF EMBODIMENTS

### Symbols of Configuring Members, Etc., and Subscripts at the End of the Symbols

In the following description, configuring members, calculation processes, signals, characteristics, and values having the same symbol such as “CW” have the same functions. In the circulation flow KN of the braking liquid BF, the side of the fluid pump QA close to the discharge part Qo (the side away from the intake part Qi) is referred to as “upstream side”, and the side of the fluid pump QA close to the intake part Qi (the side away from the discharge part Qo) is referred to as “downstream side”.

The cylinders CM, CS, the fluid pump QA, the differential pressure valve UA, the inlet valve VI, the wheel cylinder CW, the reservoirs RV, RA, and the like are connected by a fluid path. Here, the “fluid path” is a path for moving the braking liquid BF so as to transmit the liquid pressure, and corresponds to a piping, a flow path in the fluid unit HU, a hose, and the like. In the following description, the master path HM, the wheel path HW, the reflux path HK, the reservoir path HR, the depressurization path HG, the servo path HV, and the like are fluid paths.

### First Embodiment of Braking Control Device SC

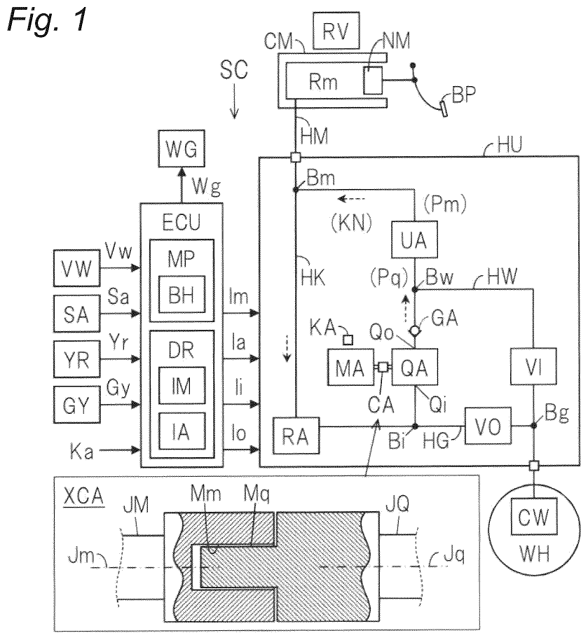

A first embodiment of a braking control device SC will be described with reference to the schematic view of FIG. 1. FIG. 1 schematically illustrates an actuator 5 (in particular, one wheel of the wheel cylinder CW) disclosed in Japanese Unexamined Patent Publication No. 2018-069923 as a fluid unit HU configuring a braking control device SC.

The braking control device SC according to the first embodiment is a general-purpose device for executing anti-lock brake control (also referred to as “ABS control”), sideslip prevention control (ESC: Electronic Stability Control), and traction control. Furthermore, in the braking control device SC, in addition to these controls, automatic braking control is executed. The automatic braking control automatically decelerates the vehicle so as to avoid collision with an obstacle or reduce damage at the time of collision based on a required deceleration from a driving assistance device.

The vehicle provided with the braking control device SC includes a braking operation member BP. The brake operating member (e.g., brake pedal) BP is a member operated by the driver to decelerate the vehicle. In addition, the vehicle is provided with a braking device (not illustrated). The braking device includes a brake caliper, a friction member (e.g., a brake pad), and a rotating member (e.g., a brake disc). The brake caliper is provided with the wheel cylinder CW. When the wheel pressure Pw is supplied from the braking control device SC to the wheel cylinder CW, the friction member is pressed against the rotating member fixed to the wheel WH. As a result, a braking force is generated on the wheel WH. Specifically, a braking torque is applied to the wheel WH by the wheel pressure Pw, and a braking force of the wheel WH is generated by the braking torque.

The vehicle is provided with various sensors for executing anti-lock brake control, sideslip prevention control, traction control, and the like. Specifically, the wheel speed sensor VW is provided to detect the rotational speed Vw (wheel speed) of the wheel WH. In addition, a steering operation amount sensor SA is provided to detect an operation amount Sa (a steering operation amount, for example, a steering angle) of a steering operation member (not illustrated). Furthermore, a vehicle (in particular, the vehicle body) is provided with a yaw rate sensor YR that detects the yaw rate Yr, a longitudinal acceleration sensor GX that detects the longitudinal acceleration Gx, and a lateral acceleration sensor GY that detects the lateral acceleration Gy. The sensor signals thereof are input to a controller ECU. Accordingly, the anti-lock brake control, the sideslip prevention control, the traction control, and the like are executed by the controller ECU.

The vehicle includes a master cylinder CM that generates the master pressure Pm in accordance with the operation of the braking operation member BP. A master piston NM is inserted into the master cylinder CM, and a liquid pressure chamber Rm (referred to as a “master chamber”) is formed. The braking operation member BP is connected to the master piston NM, and the master piston NM is moved in conjunction with the operation of the braking operation member BP. The master cylinder CM (in particular, the master chamber Rm) and the wheel cylinder CW are connected by fluid paths such as a master path HM, a reflux path HK, and a wheel path HW. The master pressure Pm is supplied as the wheel pressure Pw from the master cylinder CM to the wheel cylinder CW by the movement of the master piston NM. The braking control device SC is provided between the master cylinder CM and the wheel cylinder CW. The braking control device SC includes the fluid unit HU and the controller ECU.

### Fluid Unit HU

According to the fluid unit HU of the braking control device SC, the master pressure Pm is individually adjusted (increased or decreased) in each wheel cylinder CW, and is supplied to the wheel cylinder CW as the wheel pressure Pw. The fluid unit HU includes an electric motor MA, a fluid pump QA, a differential pressure valve UA, a pressure adjusting reservoir RA, an inlet valve VI, and an outlet valve VO.

The fluid pump QA is driven by the electric motor MA. The electric motor MA and the fluid pump QA are connected by a coupling part CA. Then, the rotational power of the electric motor MA is transmitted to the fluid pump QA via the coupling part CA. Specifically, as illustrated in the blowout portion XCA, a plane Mm (referred to as a “motor end plane”) parallel to the motor rotation axis Jm is formed at the end of a shaft member JM of the electric motor MA. Furthermore, a plane Mq (referred to as a “pump end plane”) parallel to the pump rotation axis Jq is formed at an end of a shaft member JQ of the fluid pump QA. Power is transmitted by contact between the motor end plane Mm and the pump end plane Mq. Alternatively, a buffer member may be provided between the motor end plane Mm and the pump end plane Mq, and power transmission may be performed by contact via the buffer member. For example, an elastic body such as rubber or a resin is adopted as the buffer member.

The coupling part CA is also called a “coupling” or a “shaft joint”. The two shaft members (i.e., the motor shaft member JM and the pump shaft member JQ) are coupled by the coupling part CA, and power is transmitted. For example, an Oldham's shaft joint, a flexible shaft joint, or the like is adopted as the coupling part CA. The coupling part CA may be configured such that a convex portion is formed at one end portion of the motor shaft member JM and the pump shaft member JQ, a concave portion is formed at the other end portion of the motor shaft member JM and the pump shaft member JQ, and the convex portion is inserted (e.g., press-fitted) into the concave portion.

The electric motor MA is provided with a rotation angle sensor KA so as to detect a rotation angle Ka (also referred to as a “motor rotation angle”) of the rotor (rotor). The detected motor rotation angle Ka is input to the controller ECU. Then, in the controller ECU, the motor rotation number Na is calculated based on the motor rotation angle Ka. Specifically, the motor rotation angle Ka is time-differentiated to determine the motor rotation number Na.

In the fluid pump QA, the intake part Qi and the discharge part Qo are connected by a reflux path HK (fluid path). The reflux path HK is provided with the normally-open differential pressure valve UA. The differential pressure valve UA is a linear type electromagnetic valve whose valve opening amount is continuously controlled based on an energized state (e.g., the supply current Ia). A check valve GA is provided in the vicinity of the discharge part Qo of the reflux path HK. Specifically, in the reflux path HK, the check valve GA is disposed between the discharge part Qo of the fluid pump QA and the differential pressure valve UA. In the check valve GA, the flow in the direction of one side is allowed, but the flow in the direction of the other side (the side opposite to the one side) is inhibited. That is, since the braking liquid BF flows only in the direction of one side in the reflux path HK by the check valve GA, the fluid pump QA can rotate only in one direction (i.e., the fluid pump QA cannot rotate in the other direction.). A pressure adjusting reservoir RA is provided on the downstream side of the fluid pump QA in the reflux path HK. Specifically, the pressure adjusting reservoir RA is disposed between the differential pressure valve UA and the intake part Qi of the fluid pump QA.

The reflux path HK is connected to the master chamber Rm of the master cylinder CM by way of the master path HM (fluid path) at a site Bm between the differential pressure valve UA and the pressure adjusting reservoir RA. The reflux path HK is connected to the wheel cylinder CW by way of the wheel path HW (fluid path) at a site Bw between the check valve GA and the differential pressure valve UA. A normally-open type inlet valve VI is provided in the wheel path HW (corresponding to a “liquid pressure transmission path from the output pressure Pq to the wheel pressure Pw”). The wheel path HW is connected to the intake part Qi of the fluid pump QA and the pressure adjusting reservoir RA by way of the pressure reducing path HG (fluid path) at a site Bg between the inlet valve VI and the wheel cylinder CW. Specifically, the site Bi between the pressure adjusting reservoir RA of the reflux path HK and the intake part Qi and the site Bg of the wheel path HW are connected by the pressure reducing path HG. A normally-closed outlet valve VO is provided in the pressure reducing path HG. An on/off type electromagnetic valve is employed as the inlet valve VI and the outlet valve VO. The inlet valve VI and the outlet valve VO are provided for each wheel cylinder CW so that each wheel pressure Pw can be individually adjusted.

When the fluid unit HU is not driven (i.e., when no power is supplied to the differential pressure valve UA, the electric motor MA, and the inlet valve VI,), the master pressure Pm generated in the master chamber Rm is supplied to the wheel cylinder CW via the master path HM, the reflux path HK, and the wheel path HW, which are the liquid pressure transmission paths. When power is supplied to the electric motor MA and the electric motor MA is driven, a circulation flow KN of “Qo→GA→UA→RA→Qi” is generated in the reflux path HK as indicated by a broken arrow. When power is not supplied to the differential pressure valve UA and the differential pressure valve UA is in a fully opened state, the liquid pressure Pq (referred to as “adjustment pressure” and corresponds to “output pressure”) on the upstream side is equal to the liquid pressure Pm (master pressure) on the downstream side with respect to the differential pressure valve UA in the reflux path HK (i.e., “Pq=Pm”).

When the energization amount Ia (supply current) to the differential pressure valve UA is increased, the valve opening amount of the differential pressure valve UA is reduced. As a result, the circulation flow KN (the flow of the braking liquid BF circulating in the reflux path HK) is throttled by the differential pressure valve UA, and the flow of the circulation flow KN is inhibited. In other words, the flow path of the reflux path HK is narrowed by the differential pressure valve UA, and the orifice effect by the differential pressure valve UA is exerted. As a result, the liquid pressure Pq (adjustment pressure) on the upstream side of the differential pressure valve UA is increased from the liquid pressure Pm (master pressure) on the downstream side. That is, in the circulation flow KN, a liquid pressure difference (differential pressure) between the adjustment pressure Pq and the master pressure Pm is generated with respect to the differential pressure valve UA. The differential pressure is adjusted by the supply current Ia to the differential pressure valve UA. The differential pressure (as a result, the adjustment pressure Pq) generated by the differential pressure valve UA is used for executing the automatic braking control, the traction control, and the sideslip prevention control.

In the braking control device SC, the inlet valve VI and the outlet valve VO are controlled, and the reduction, increase, and holding of the wheel pressure Pw are individually performed for each wheel cylinder CW. The individual adjustment of the wheel pressure Pw is used for executing the anti-lock brake control, the traction control, and the sideslip prevention control. When power is not supplied to the inlet valve VI and the outlet valve VO and their operations are stopped, the inlet valve VI is opened and the outlet valve VO is closed. In this state, the wheel pressure Pw is equal to the adjustment pressure Pq. In order to reduce the wheel pressure Pw, the inlet valve VI is closed and the outlet valve VO is opened. Since the inflow of the braking liquid BF into the wheel cylinder CW is inhibited and the braking liquid BF in the wheel cylinder CW flows out to the pressure adjusting reservoir RA, the wheel pressure Pw is reduced. In order to increase the wheel pressure Pw, the inlet valve VI is opened and the outlet valve VO is closed. Since the outflow of the braking liquid BF to the pressure adjusting reservoir RA is inhibited and the adjustment pressure Pq is supplied to the wheel cylinder CW, the wheel pressure Pw is increased. Here, the upper limit of the increase in the wheel pressure Pw is the adjustment pressure Pq. In order to maintain the wheel pressure Pw, both the inlet valve VI and the outlet valve VO are closed. Since the wheel cylinder CW is fluidly sealed, the wheel pressure Pw is maintained constant.

### Controller ECU

The fluid unit HU is controlled by a controller ECU (also referred to as an “electronic control unit”). The controller ECU includes a microprocessor MP and a drive circuit DR.

The wheel speed Vw, the steering operation amount Sa, the yaw rate Yr, the lateral acceleration Gy, and the motor rotation angle Ka are input to the controller ECU (in particular, the microprocessor MP). The controller ECU calculates a vehicle body speed Vx based on the wheel speed Vw. The automatic braking control, the anti-lock brake control, the traction control, and the sideslip prevention control are executed based on the signals of the vehicle body speed Vx, the wheel speed Vw, the steering operation amount Sa, the yaw rate Yr, and the lateral acceleration Gy. Specifically, the electric motor MA configuring the fluid unit HU and various electromagnetic valves (UA and the like) are driven by the controller ECU. In the drive circuit DR of the controller ECU, an H-bridge circuit is configured by a switching element (e.g., a MOS-FET) so as to drive the electric motor MA based on the motor rotation angle Ka. In addition, the drive circuit DR includes a switching element so as to drive various solenoid valves (UA etc.). The supply current Ia to the differential pressure valve UA (also referred to as “differential pressure valve current”), the supply current Ii to the inlet valve VI (also referred to as “inlet valve current”), the supply current Io to the outlet valve VO, and the supply current Im to the electric motor MA (also referred to as “motor current”) are controlled based on a control algorithm programmed in the microprocessor MP. The drive circuit DR is provided with a differential pressure valve current sensor IA that detects the supply current Ia to the differential pressure valve UA, an inlet valve current sensor II (not illustrated) that detects the supply current Ii to the inlet valve VI, and a motor current sensor IM that detects the supply current Im to the electric motor MA.

Furthermore, the controller ECU (in particular, the microprocessor MP) includes an appropriateness determination block BH for determining “whether coupling part CA is normal or abnormal”. This determination is called “appropriateness determination”. In the appropriateness determination block BH (also simply referred to as a “determination block”), an algorithm for appropriateness determination is programmed. The appropriateness determination is executed when the vehicle is stopped. For example, the appropriateness determination is executed as an initial check of the braking control device SC when the ignition switch is turned on. Alternatively, the operation may be executed when a door of the vehicle is opened for the driver to get on the vehicle (e.g., in a case where the courtesy switch is turned on). Furthermore, the appropriateness determination may be performed before the execution of the automatic traveling (e.g., automatic parking control such as remote parking control). Here, the “remote parking control” is a function of automatically performing parking by remote operation by a smartphone or the like.

A signal of the state quantity Ma related to the electric motor MA is input to the appropriateness determination block BH. The “state quantity Ma related to the electric motor MA” is also called a “motor state quantity”. For example, as the motor state quantity Ma, the motor rotation angle Ka detected by the motor rotation angle sensor KA is input to the appropriateness determination block BH. In addition, the supply current Im (motor current) detected by the motor current sensor IM is input to the appropriateness determination block BH as the motor state quantity Ma. Furthermore, in the appropriateness determination block BH, the motor rotation number Na is input as the motor state quantity Ma.

In the appropriateness determination block BH, in a case where the valve opening amount of the differential pressure valve UA is reduced in a state where the electric motor MA is steadily driven, the appropriateness determination on “whether or not coupling part CA is normal” is performed based on the change (increase or decrease) of the motor state quantity Ma. When the driving of the electric motor MA is started (i.e., at the time of startup,), an inrush current (also referred to as “startup current”) flows to the electric motor MA. Thereafter, the motor current Im becomes substantially constant. The “steady driving” means that the electric motor MA is driven while maintaining a constant state (e.g., constant state of motor rotation number Na and motor current Im) after generation of an inrush current. Furthermore, the “reduction in the valve opening amount of the differential pressure valve UA” includes that the differential pressure valve UA is completely closed.

In the appropriateness determination, the components of the fluid unit HU such as the electric motor MA, the differential pressure valve UA, and the inlet valve VI are driven. A series of driving of the electric motor MA and the like in the appropriateness determination is called “determination mode drive”. That is, in the appropriateness determination block BH, the appropriateness (whether normal or not) of the coupling part CA is determined from the change in the motor state quantity Ma when the determination mode drive is executed. The determination mode drive is executed in a stop state (i.e., the state of “Vx=0”) of the vehicle. In addition, a state in which the braking operation member BP is not operated (i.e., the state of “Ba=0”) may be added to the execution condition.

When the appropriateness determination block BH determines abnormality of the coupling part CA, the abnormality is notified to the driver by the notification device WG. For example, a notification signal Wg is output from the appropriateness determination block BH of the controller ECU to the notification device WG. As a result, the notification device WG notifies the driver of the abnormal state of the coupling part CA by sound, light, or the like.

### Outline of Appropriateness Determination of Coupling Part CA

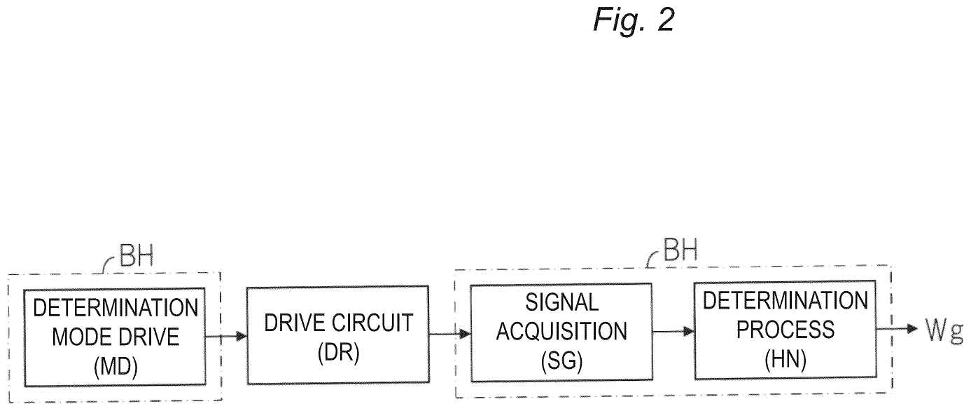

The appropriateness determination executed by the appropriateness determination block BH will be outlined with reference to the block diagram of FIG. 2. The processing of the appropriateness determination block BH is programmed in the controller ECU. In the appropriateness determination, a load is applied to the electric motor MA which is a power source for generating the circulation flow KN by narrowing (or closing) the valve opening amount of the differential pressure valve UA or the like. The appropriateness of the coupling part CA is determined based on the change in the state quantity Ma related to the electric motor MA at this time. The appropriateness determination block BH includes a determination mode drive block MD, a signal acquisition block SG, and a determination processing block HN.

In the determination mode drive block MD, the electric motor MA, the differential pressure valve UA, and the like are driven based on a pattern set in advance. That is, an instruction is issued from the determination mode drive block MD to the drive circuit DR. For example, the determination mode drive is executed at the time of non-braking in the stop state (i.e., the state of “Vx=0, Ba=0”).

In the signal acquisition block SG, a signal of the motor state quantity Ma (state quantity related to the electric motor MA) in the determination mode drive is acquired. Specifically, the motor state quantity Ma includes the motor current Im, the motor rotation angle Ka, the motor rotation number Na, and the like. The motor current Im is detected by a motor current sensor IM provided in the drive circuit DR. The motor rotation angle Ka is detected by a motor rotation angle sensor KA provided in the electric motor MA. The motor rotation number Na is determined by time-differentiation based on the motor rotation angle Ka.

In the determination processing block HN, the appropriateness determination as to whether or not the coupling part CA is normal is executed based on the change (increase or decrease) in the motor state quantity Ma during the determination mode drive. Although details will be described later, the normal state of the coupling part CA is determined within the determination period based on the satisfaction of the determination condition. Then, when the normal state is not determined within the determination period, the abnormal state of the coupling part CA is determined at the end of the determination period.

The electric motor MA and the fluid pump QA are connected by way of a coupling part CA. When the electric motor MA is driven, the braking liquid BF is discharged from the fluid pump QA, and the circulation flow KN is generated in the reflux path HK. The reflux path HK is provided with a differential pressure valve UA. When the valve opening amount of the differential pressure valve UA is reduced (or, the differential pressure valve UA is fully closed.), the circulation flow KN becomes difficult to flow. Therefore, when the coupling part CA is normal, the load of the electric motor MA increases. On the other hand, when there is an abnormality in the coupling part CA, the increase in the load of the electric motor MA is small (or does not substantially increase). That is, the load on the electric motor MA when the flow path is narrowed by the differential pressure valve UA is large in the normal state of the coupling part CA and small in the abnormal state. In the determination processing block HN, based on this event, the appropriateness of the coupling part CA is determined based on the change in the state quantity Ma related to the electric motor MA. The outline of the appropriateness determination has been described above. Next, specific processing examples (first to third processing examples) of the appropriateness determination will be described.

### First Processing Example of Appropriateness Determination

Details of a first processing example related to the appropriateness determination will be described.

In the first processing example, “State quantity (state variable) until output as torque of the electric motor MA from the motor current Im” is adopted as the motor state quantity Ma for appropriateness determination. The state quantity is a state quantity related to the torque output of the electric motor MA, and is called an “output equivalent value Tm (value corresponding to the torque output of the electric motor MA)”. For example, the output equivalent value Im is calculated based on the motor current Im (detection value of the motor current sensor IM). In addition, the motor current Im itself may be adopted as the output equivalent value Tm. In the configuration including the torque sensor that detects the output of the electric motor MA, the motor torque detected by the sensor can be adopted as the output equivalent value Tm.

In the first processing example, the determination period is set as “until the determination time th elapses from the time point of start of power supply to the differential pressure valve UA”. The determination time th is a predetermined value (constant) set in advance. That is, when the time point at which the power supply to the differential pressure valve UA is started is set as “0 (start point)”, “T=0 (start point)” to “T=th (end point)” in the elapse of time T is the determination period. The determination period according to the first processing example is also referred to as an “output determination period” in order to be distinguished from other determination periods.

In the first processing example, the determination condition is that “the state in which the output equivalent value Im is greater than or equal to the determination threshold value ix is maintained over the duration tj”. The determination threshold value ix and the duration tj are predetermined values (constants) set in advance. The duration tj is provided to eliminate the influence of noise or the like. The determination condition according to the first processing example is also referred to as a “first determination condition” in order to be distinguished from other determination conditions. When the first determination condition is satisfied, the normal state of the coupling part CA is determined. That is, the first determination condition is a condition for determining the normal state of the coupling part CA.

In the determination mode drive of the first processing example, first, the electric motor MA is driven in the forward rotation direction so that the rotation number Na of the electric motor MA becomes the constant rotation number na. Specifically, the target rotation number Nt of the electric motor MA is set to a constant rotation number na (predetermined value set in advance). Then, the torque output of the electric motor MA is controlled such that the motor rotation number Na matches the target rotation number Nt (=na). Since the output of the electric motor MA has a correlation with the motor current Im, the supply current Im to the electric motor MA is adjusted by the rotation number feedback control. At this time, since the differential pressure valve UA and the inlet valve VI are not energized, they are in a fully opened state. Therefore, when the motor current Im having the value ia is supplied to the electric motor MA, the motor rotation number Na continues to rotate at the constant rotation number na (i.e., the steady driving state of “Im=ia, Na=na (constant rotation number)”). Next, power is supplied to the differential pressure valve UA and the inlet valve VI in a steady state in which the electric motor MA is driven at a constant rotation number na. As a result, the valve opening amount of the differential pressure valve UA is reduced, and the inlet valve VI is closed.

The appropriateness determination is executed based on a change (in particular, an increase) in the output equivalent value Tm during the determination period. Specifically, within the determination period, the state of “Tm≥ix” is continued for the duration tj, and when the first determination condition is satisfied, determination is made that the coupling part CA is normal. On the other hand, within the output determination period, when the state of “Tm<ix” is continued or “Tm≥ix” is achieved but when the relevant state is not continued over the duration tj and the first determination condition is not satisfied, determination is made that the coupling part CA is abnormal. When the abnormality of the coupling part CA is determined, the notification signal Wg is output to the notification device WG. The notification device WG notifies the driver of the abnormal state of the coupling part CA.

The determination mode drive ends at the end point of the determination period. When the determination mode drive is terminated, the power supply to the electric motor MA, the differential pressure valve UA, and the like is stopped. Note that the determination mode drive may be terminated at the time point when the determination condition is satisfied.

In the determination mode drive, since the inlet valve VI is completely closed, the braking liquid BF is not moved toward the wheel cylinder CW. In addition, since the valve opening amount of the differential pressure valve UA is reduced by the power supply to the differential pressure valve UA, a load is generated in the electric motor MA when the braking liquid BF passes through the differential pressure valve UA. Since the output equivalent value Im is rotation number feedback controlled such that the motor rotation number Na is maintained at the constant rotation number na, the load of the electric motor MA increases and the output equivalent value Tm increases when the coupling part CA is normal. Therefore, when the determination condition is satisfied, normality of the coupling part CA is determined. On the other hand, when there is an abnormality in the coupling part CA, power is not transmitted from the electric motor MA to the fluid pump QA, and the braking liquid BF is not discharged from the fluid pump QA, or the discharge amount thereof is small. When there is an abnormality in the coupling part CA, the output equivalent value Tm does not increase much. Therefore, when the first determination condition is satisfied, normality of the coupling part CA is determined, but when the first determination condition is not satisfied, abnormality of the coupling part CA is determined.

In the first processing example, the inlet valve VI may not be closed. In this case, the braking liquid BF is moved to the wheel cylinder CW, but since the components of the braking device (wheel cylinder CW, brake caliper, friction member, and the like) have sufficient rigidity, a load on the electric motor MA is generated. In the first processing example, closing the inlet valve VI by energization is not an essential condition in the determination mode drive.

### Operation of First Processing Example

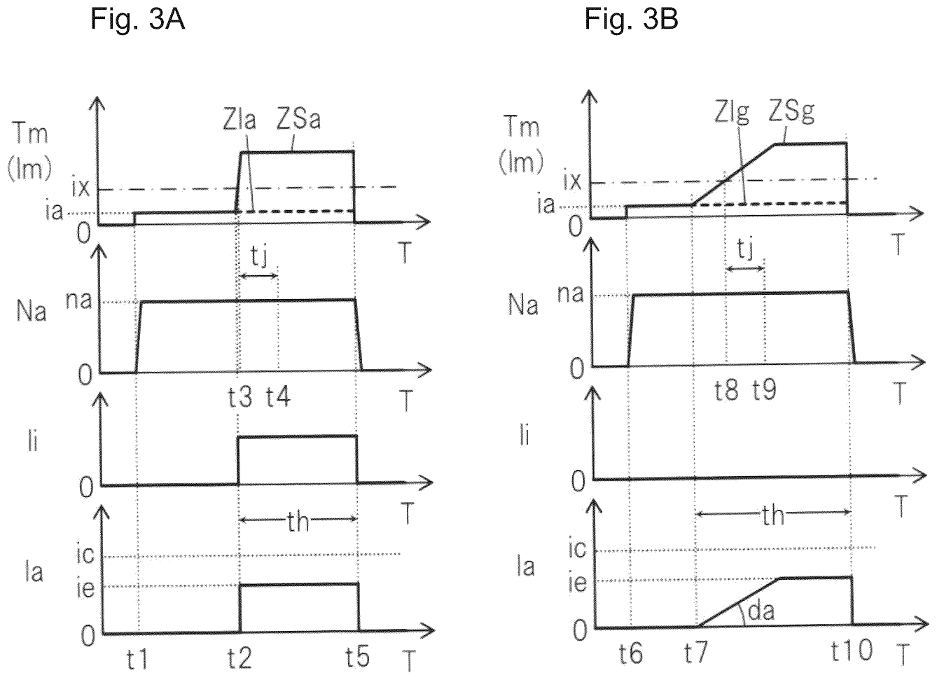

The operation of the first processing example related to the appropriateness determination will be described with reference to the time-series diagrams of FIGS. 3A and 3B (diagrams representing transition of various state quantities with elapse of time T). The determination mode drive of the first processing example has the following four modes in combination of the power supply methods of the differential pressure valve UA and the inlet valve VI. In the first processing example, regardless of which of these is adopted, the appropriateness of the coupling part CA is determined according to the output determination period and the first determination condition.

(1) Mode in which the inlet valve VI is fully closed and the power supply to the differential pressure valve UA is performed in a stepwise manner (referred to as “mode 1a”).

(2) Mode in which the power is gradually supplied to the differential pressure valve UA while the inlet valve VI is kept opened (referred to as “mode 1b”).

(3) Mode in which the inlet valve VI is fully closed and power supply to the differential pressure valve UA is gradually performed (referred to as “mode 1c”).

(4) Mode in which the power is supplied to the differential pressure valve UA in a stepwise manner while the inlet valve VI is kept opened (referred to as “mode 1d”).

Operation of [Mode 1a]

The above [mode 1a] will be described with reference to 3A. In the operation example, a situation is assumed in which the coupling part CA is broken and the electric motor MA is idling in the abnormality of the coupling part CA. Note that when the electric motor MA is started, a startup current (inrush current) is generated, and a large current temporarily flows as the motor current Im, but this is omitted in the following diagrams (FIGS. 3A, 3B, 4A, 4B, 5A, 5B, 6A, 6B).

At time point t1, determination mode drive is started. After the inrush current is generated, the electric motor MA is steadily driven in the forward rotation direction. That is, the supply current Im to the electric motor MA is increased so that the rotation number Na of the electric motor MA matches the target rotation number Nt (=na). Accordingly, the output equivalent value Im increases. After the motor rotation number Na matches the target rotation number na, the motor current Im is maintained at the constant value ia, and the output equivalent value Tm becomes constant.

At time point t2 when the electric motor MA is steadily driven, the inlet valve VI and the differential pressure valve UA are driven in the determination mode. The supply current Ii (inlet valve current) to the inlet valve VI is increased, and the inlet valve VI is completely closed. In addition, the supply current Ia (differential pressure valve current) to the differential pressure valve UA is increased, and the valve opening amount of the differential pressure valve UA is reduced. Note that the differential pressure valve current Ia is less than the valve closing current ic, and the differential pressure valve UA is not completely closed. The valve closing current ic is a current value for completely closing the differential pressure valve UA, and is a predetermined value (constant) set in advance. At time point t2, counting of the time T related to the determination time th is started. In the diagram, the output determination period is a period (section) from time point t2 to time point t5.

A case where the coupling part CA is normal will be described with reference to the characteristic line ZSa indicated by a solid line. At a normal time of the coupling part CA, the braking liquid BF hardly flows in the circulation flow KN due to the closing of the inlet valve VI and the reduction in the valve opening amount of the differential pressure valve UA. Therefore, the load of the electric motor MA increases. The output equivalent value Im is increased by the rotation number feedback control such that the motor rotation number Na matches the target rotation number na. Therefore, at time point t3 immediately after time point t2, the output equivalent value Im reaches the determination threshold value ix. From time point t3, counting of the time T related to the duration tj is performed. At time point t4, the first determination condition is satisfied, and in the appropriateness determination, determination is made that the coupling part CA is normal.

Next, a case where the coupling part CA is abnormal will be described with reference to a characteristic line ZIa indicated by a broken line. At an abnormal time of the coupling part CA, the load of the electric motor MA does not increase or only slightly increases, so that the output equivalent value Tm does not increase. Therefore, a state in which the output equivalent value Tm is less than the determination threshold value ix continues, and the first determination condition is not satisfied within the output determination period. Therefore, at time point t5, determination is made that the coupling part CA is abnormal.

At the end time point t5 of the determination period, the determination mode drive is terminated, and the power supply to the electric motor MA, the inlet valve VI, and the differential pressure valve UA is stopped. Note that the determination mode drive may be terminated at time point t4 when the first determination condition is satisfied.

Operation of [Mode 1b]

The above [mode 1b] will be described with reference to FIG. 3B. The difference from [mode 1a] is that “the inlet valve VI is kept opened” and that “the power supply to the differential pressure valve UA is gradually performed” in the determination mode drive. Hereinafter, the differences will be mainly described.

At time point t6, the determination mode drive is started, and the electric motor MA is driven in the forward rotation direction. That is, the supply current Im to the electric motor MA is increased so that the rotation number Na of the electric motor MA becomes the target rotation number Nt (=na). Thereafter, the electric motor MA is driven in a steady state of “Na=na”.

At time point t7 when the electric motor MA is steadily driven, the differential pressure valve UA starts to be driven. In [mode 1b], power is not supplied to the inlet valve VI, and the inlet valve VI is kept opened. From time point t7, the differential pressure valve current Ia gradually increases in a predetermined time gradient da (referred to as “increasing gradient”). When the differential pressure valve current Ia reaches the predetermined current ie (also referred to as “differential pressure valve predetermined current”), the differential pressure valve current Ia is thereafter maintained at the predetermined current ie. The increasing gradient da (change amount of the differential pressure valve current Ia with respect to time) and the predetermined current ie (differential pressure valve predetermined current) are predetermined values (constants) set in advance. From time point t7, counting of the time T related to the determination time th is started. In [mode 1b], the output determination period is from time point t7 (start point) to time point t10 (end point).

At the normal time of the coupling part CA, the load of the electric motor MA increases as the valve opening amount of the differential pressure valve UA reduces after time point t7. At time point t8, it is satisfied for the first time that the output equivalent value Im is greater than or equal to the determination threshold value ix. Then, at time point t9, the state of “Tm≥ix” is continued over the duration tj (see the characteristic line ZSg indicated by the solid line). Accordingly, at time point t9, the first determination condition is satisfied and determination is made that that the coupling part CA is normal. At an abnormal time of the coupling part CA, the load of the electric motor MA does not increase, and thus the output equivalent value Im does not increase (see the characteristic line ZIg indicated by the broken line). Since the state in which the output equivalent value Tm is less than the determination threshold value ix is continued and the first determination condition is not satisfied, determination is made that the coupling part CA is abnormal at time point t10. In [mode 1b] as well, the determination mode drive is terminated at the end point t10 of the determination period. When the determination mode drive is terminated, the power supply to the electric motor MA and the differential pressure valve UA is stopped. Note that the determination mode drive may be terminated at time point t9 when the first determination condition is satisfied.

### Second Processing Example of Appropriateness Determination

Details of a second processing example related to the appropriateness determination will be described.

In the second processing example, the motor rotation number Na is adopted as the motor state quantity Ma for appropriateness determination. For example, the motor rotation number Na is calculated based on the detection result (i.e., the motor rotation angle Ka) of the motor rotation angle sensor KA. The determination period of the second processing example is “until the determination time th (predetermined value set in advance) elapses from the time point of start of power supply to the differential pressure valve UA” as in the first processing example. The determination period according to the second processing example is also referred to as a “rotation number determination period” in order to be distinguished from other determination periods.

In the second processing example, the determination condition is set as “a state in which the motor rotation number Na is smaller than or equal to the determination rotation number nx is continued over duration tj”. The determination rotation number nx and the duration tj are predetermined values (constants) set in advance. The duration tj is provided to eliminate the influence of noise or the like. The determination condition according to the second processing example is also referred to as a “second determination condition” in order to be distinguished from other determination conditions. When the second determination condition is satisfied, the normal state of the coupling part CA is determined. That is, the second determination condition is a condition for determining the normal state of the coupling part CA.

determination mode drive of the second processing example will be described. In the first processing example, the electric motor MA is driven by the rotation number feedback control, but in the second processing example, the rotation number feedback control is not performed, and a constant motor current Im (value im) is supplied to the electric motor MA. In the determination mode drive, first, the constant current im is supplied to the electric motor MA. The constant current im is a predetermined value (constant) set in advance. At this time, the power supply to the differential pressure valve UA and the inlet valve VI is stopped, and they are in a fully opened state. The rotation number Na of the electric motor MA becomes a constant steady state at a value nm. In this state, power is supplied to the differential pressure valve UA and the inlet valve VI. As a result, the valve opening amount of the differential pressure valve UA is reduced, and the inlet valve VI is completely closed.

The appropriateness determination is executed based on a change in the motor rotation number Na during the determination period. Specifically, in a case where the state of “Na≤nx” is continued for the duration tj and the second determination condition is satisfied in the rotation number determination period, determination is made that the coupling part CA is normal. On the other hand, in a case where the state of “Na>nx” is continued or “Na>nx” is achieved but the state does not continue over the duration tj and the second determination condition is not satisfied in the rotation number determination period, determination is made that the coupling part CA is abnormal. When the abnormality of the coupling part CA is determined, the notification signal Wg is output to the notification device WG. The notification device WG notifies the driver of the abnormal state of the coupling part CA.

As described above, if the coupling part CA is normal, a load is generated in the electric motor MA when the valve opening amount of the differential pressure valve UA is reduced. Since the supplied motor current Im is a constant value im, the motor rotation number Na should decrease as the load increases. When there is an abnormality in the coupling part CA, the motor rotation number Na does not decrease so much in the determination mode drive. Therefore, in the determination mode drive, when the second determination condition is satisfied, it is determined that the coupling part CA is normal, but when the second determination condition is not satisfied, it is determined that the coupling part CA is abnormal.

In the second processing example as well, similarly to the first processing example, the inlet valve VI may not be closed. This is because a load on the electric motor MA is generated by the rigidity of the braking device (CW, brake caliper, friction member, etc.). Therefore, also in the second processing example, closing the inlet valve VI by energization is not an essential condition in the determination mode drive.

### Operation of Second Processing Example

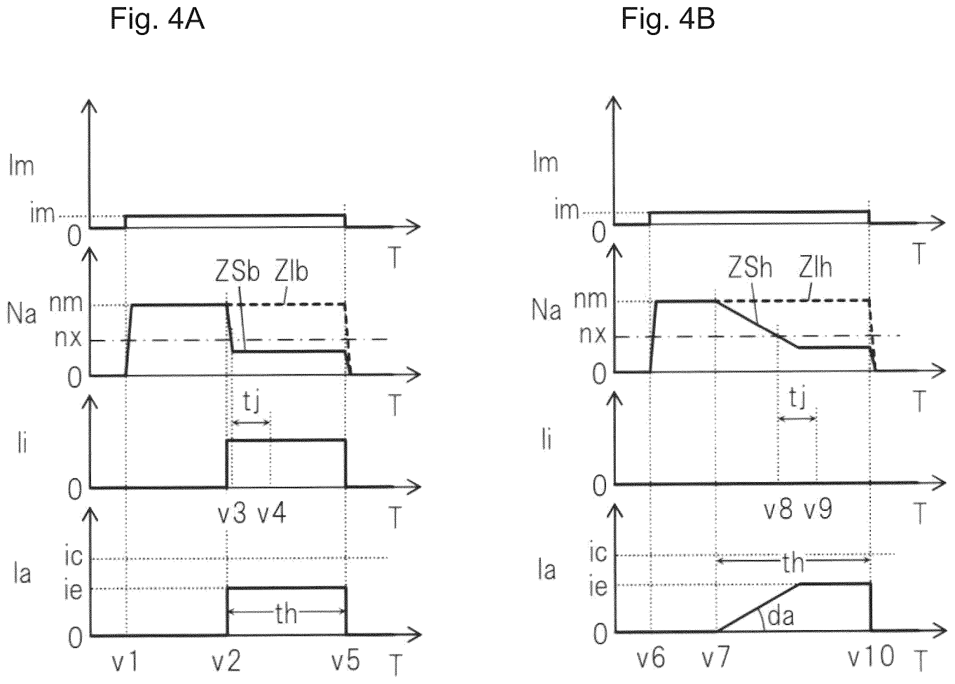

The operation of the second processing example related to the appropriateness determination will be described with reference to the time-series diagrams of FIGS. 4A and 4B (diagrams representing transition of various state quantities with elapse of time T). The determination mode drive of the second processing example has the following four modes in combination of the power supply methods of the differential pressure valve UA and the inlet valve VI. In the second processing example, regardless of which of these is adopted, the appropriateness of the coupling part CA is determined according to the rotation number determination period and the second determination condition.

(1) Mode in which the inlet valve VI is fully closed and the power supply to the differential pressure valve UA is performed in a stepwise manner (referred to as “mode 2a”).

(2) Mode in which the power is gradually supplied to the differential pressure valve UA while the inlet valve VI is kept opened (referred to as “mode 2b”).

(3) Mode in which the inlet valve VI is fully closed and power supply to the differential pressure valve UA is gradually performed (referred to as “mode 2c”).

(4) Mode in which the power is supplied to the differential pressure valve UA in a stepwise manner while the inlet valve VI is kept opened (referred to as “mode 2d”).

Operation of [Mode 2a]

The above [mode 2a] will be described with reference to FIG. 4A. In the operation example, a situation is assumed in which the coupling part CA is broken and the electric motor MA is idling in the abnormality of the coupling part CA. Note that as described above, the description of the startup current when the electric motor MA is started is omitted.

At time point v1, the determination mode drive is started. After the generation of the startup current, the electric motor MA is steadily driven in the forward rotation direction. That is, a predetermined current im (constant value) set in advance is supplied to the electric motor MA. As a result, the motor rotation number Na is steadily driven at a constant rotation number nm corresponding to the predetermined current im.

At time point v2 when the electric motor MA is steadily driven, the inlet valve VI and the differential pressure valve UA are driven. At time point v2, the inlet valve VI is completely closed, and the valve opening amount of the differential pressure valve UA is reduced. Here, since “Ia <ic”, the differential pressure valve UA is not completely closed. At time point v2, counting of the time T related to the determination time th is started. In [mode 2a], the rotation number determination period is between time point v2 and time point v5.

When the coupling part CA is normal, the load of the electric motor MA increases due to the closing of the inlet valve VI and the reduction in the valve opening amount of the differential pressure valve UA. Since the motor current Im is constant, the motor rotation number Na decreases from the value nm (see the characteristic line ZSb indicated by the solid line). Therefore, the motor rotation number Na reaches the determination rotation number nx at time point v3 immediately after the start of power supply to the differential pressure valve UA. At time point v3, counting of the time T related to the duration tj is started. At time point v4, since the second determination condition is satisfied, it is determined that the coupling part CA is normal.

When the coupling part CA is abnormal, the load of the electric motor MA does not increase or only slightly increases. Therefore, the motor rotation number Na substantially does not decrease in the determination period (see the characteristic line ZIb indicated by the broken line). Since a state in which the motor rotation number Na is larger than the determination rotational speed nx is continued and the second determination condition is not satisfied, determination is made at time point v5 that the coupling part CA is abnormal.

In the second processing example as well, similarly to the first processing example, at the end time point v5 of the determination period, the determination mode drive is terminated, and the power supply to the electric motor MA, the inlet valve VI, and the differential pressure valve UA is stopped. Note that the determination mode drive may be terminated at time point v4 when the second determination condition is satisfied.

Operation of [Mode 2b]

The above [mode 2b] will be described with reference to FIG. 4B. The difference from [mode 2a] is that “the inlet valve VI is kept opened” and that “the power supply to the differential pressure valve UA is gradually performed” in the determination mode drive. Hereinafter, the differences will be mainly described.

At time point v6, the determination mode drive is started, and the electric motor MA is driven in the forward rotation direction. Specifically, the electric motor MA is supplied with “Im=im”, and the electric motor MA is steadily driven at “Na=nm”. At time point v7, the differential pressure valve UA is driven in the determination mode. In [mode 2b], no power is supplied to the inlet valve VI, and the inlet valve VI remains opened. From time point v7, the differential pressure valve current Ia is gradually increased in an increasing gradient da. When the differential pressure valve current Ia reaches the predetermined current ie, the differential pressure valve current Ia is thereafter maintained at the predetermined current ie. As described above, the increasing gradient da (the change amount in the differential pressure valve current Ia with respect to time) and the predetermined current ie are predetermined values (constants) set in advance. At time point v7, counting of the time T related to the determination time th is started. In [mode 2b], the rotation number determination period is between time point v7 and time point v10.

In the normal state of the coupling part CA, after time point v7, the load of the electric motor MA increases as the valve opening amount of the differential pressure valve UA reduces, so that the motor rotation number Na decreases. At time point v8, it is satisfied for the first time that the motor rotation number Na is less than or equal to the determination rotation number nx. Then, at time point v9, the state of “Na≤nx” is continued over the duration tj (see the characteristic line ZSh indicated by the solid line). Accordingly, at time point v9, the second determination condition is satisfied and determination is made that the coupling part CA is normal. At an abnormal time of the coupling part CA, the load of the electric motor MA does not increase, and thus the motor rotation number Na does not decrease (see the characteristic line ZIh indicated by the broken line). Since a state in which the motor rotation number Na is larger than the determination rotation number nx is continued and the second determination condition is not satisfied, it is determined at time point v10 that the coupling part CA is abnormal. In [mode 2b] as well, the determination mode drive is terminated at the end time point v10 of the determination period. When the second determination condition is satisfied, the process may be terminated at time point v9.

### Third Processing Example of Appropriateness Determination

Details of a third processing example related to the appropriateness determination will be described.

In the third processing example as well, the motor rotation number Na is adopted as the motor state quantity Ma for appropriateness determination, similarly to the second processing example. The determination period of the third processing example is “from the start time point of power supply to the differential pressure valve UA until the determination time th (predetermined value set in advance)” as in the first and second processing examples. The determination period according to the third processing example is also referred to as a “rotation number determination period” as in the second processing example.

In the third processing example, similarly to the second processing example, the determination condition is “the state in which the motor rotation number Na is less than or equal to the determination rotation number nx is continued over the duration tj”. The determination rotation number nx and the duration tj are predetermined values (constants) set in advance. For example, the determination rotation number nx can be set to “0 (stop state of the electric motor MA)”. The duration tj is provided to eliminate the influence of noise or the like. The determination condition according to the third processing example is also referred to as a “third determination condition” in order to be distinguished from other determination conditions. When the third determination condition is satisfied, the normal state of the coupling part CA is determined. That is, the third determination condition is a condition for determining the normal state of the coupling part CA.

In the determination mode drive of the third processing example, first, the electric motor MA is driven. In the third determination example, similarly to the first determination example, the motor rotation number Na is controlled to be a constant rotation number na (a predetermined value set in advance) by the rotation number feedback control of the electric motor MA. Alternatively, similarly to the second determination example, the electric motor MA may be driven by supplying a constant current im (predetermined value set in advance) as the motor current Im. Both the differential pressure valve UA and the inlet valve VI are completely closed while the electric motor MA is being driven in the steady state. That is, in the first and second processing examples, the differential pressure valve UA is opened although the valve opening amount thereof is reduced. On the other hand, in the third processing example, similarly to the inlet valve VI, the differential pressure valve UA is also completely closed.

The appropriateness determination of the third processing example is executed based on the change in the motor rotation number Na during the determination period, similarly to the second processing example. Specifically, when the third determination condition is satisfied within the rotation number determination period, it is determined that the coupling part CA is normal. On the other hand, when the third determination condition is not satisfied, it is determined that the coupling part CA is abnormal.

When the differential pressure valve UA and the inlet valve VI are completely closed, the discharge part Qo of the fluid pump QA is fluidly sealed, and hence when the coupling part CA is normal, the electric motor MA and the fluid pump QA do not rotate or only slightly rotates due to the rigidity of the fluid path, backlash of the coupling part CA, or the like. For example, when the rotation number Na of the electric motor MA does not occur at all (i.e., in the case of “Na=0”), the normal state of the coupling part CA is determined. On the other hand, when “Na>nx (=0)” and the rotation number Na of the electric motor MA is generated (i.e., in the case of “Na≠0”,), the electric motor MA is in a state of idling, and thus an abnormal state of the coupling part CA is determined. When the abnormality of the coupling part CA is determined, the notification signal Wg is output to the notification device WG, and notification to the driver is performed.

In the third processing example as well, similarly to the first and second processing examples, the inlet valve VI may not be closed. This is because a load on the electric motor MA is generated by the rigidity of the braking device (wheel cylinder CW, brake caliper, friction member, etc.). Therefore, also in the third processing example, closing the inlet valve VI by energization is not an essential condition in the determination mode drive.

### Operation of Third Processing Example

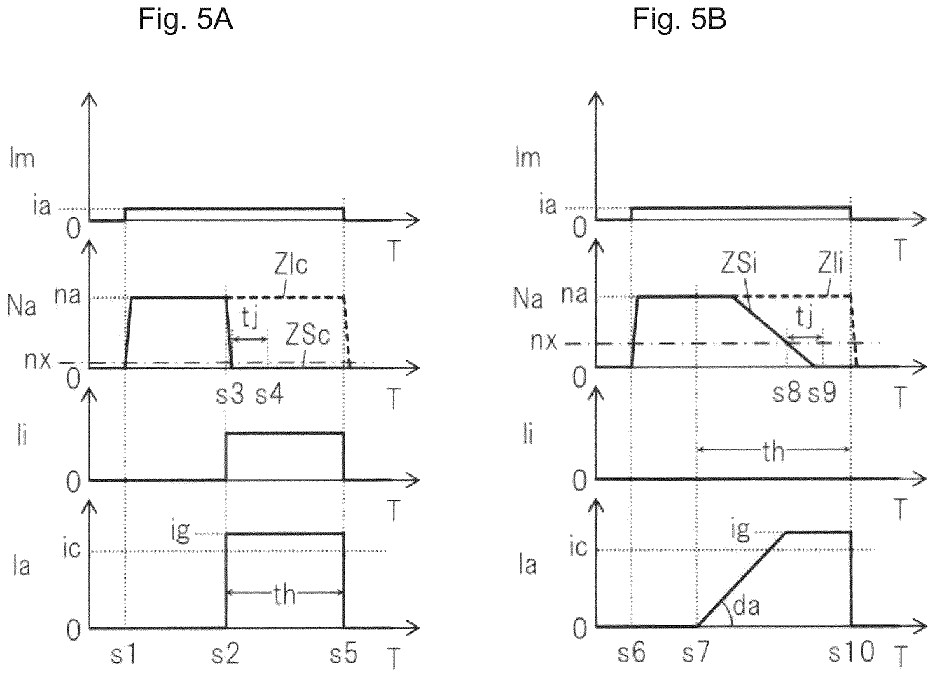

The operation of the third processing example related to the appropriateness determination will be described with reference to the time-series diagrams in FIGS. 5A and 5B. The determination mode drive of the third processing example has the following four modes in combination of the power supply methods of the differential pressure valve UA and the inlet valve VI. In the third processing example, regardless of which of these is adopted, the appropriateness of the coupling part CA is determined according to the rotation number determination period and the third determination condition.

(1) Mode in which the inlet valve VI is fully closed and the power supply to the differential pressure valve UA is performed in a stepwise manner (referred to as “mode 3a”).

(2) Mode in which the power is gradually supplied to the differential pressure valve UA while the inlet valve VI is kept opened (referred to as “mode 3b”).

(3) Mode in which the inlet valve VI is fully closed and power supply to the differential pressure valve UA is gradually performed (referred to as “mode 3c”).

(4) Mode in which the power is supplied to the differential pressure valve UA in a stepwise manner while the inlet valve VI is kept opened (referred to as “mode 3d”).

Operation of [Mode 3a]

The above [mode 3a] will be described with reference to FIG. 5A.

At time point s1, the determination mode drive is started, and the electric motor MA is driven in the forward rotation direction. From time point s1, the supply current Im to the electric motor MA is increased, and the motor rotation number Na is increased. Thereafter, the motor rotation number Na is driven in a steady state of a constant rotation number na.

At time point s2, the inlet valve VI and the differential pressure valve UA are driven in the determination mode. At time point s2, the inlet valve VI and the differential pressure valve UA are completely closed. Note that the valve closing of the differential pressure valve UA is achieved by supplying the predetermined current ig to the differential pressure valve UA. The predetermined current ig is a value larger than the valve closing current ic, and is a predetermined value (constant) set in advance. At time point s2, counting of the time T related to the determination time th is started. In [mode 3a], the rotation number determination period is from time point s2 to time point s5.

When the coupling part CA is normal, the load of the electric motor MA rapidly increases due to the fully closed state of the inlet valve VI and the differential pressure valve UA. As a result, the motor rotation number Na rapidly decreases so that the rotation of the electric motor MA stops (see the characteristic line ZSc indicated by the solid line). At time point s3 immediately after the start of power supply to the differential pressure valve UA, the motor rotation number Na decreases to the determination rotation number nx. At time point s4, since the third determination condition is satisfied, it is determined that the coupling part CA is normal. When the coupling part CA is abnormal (e.g., in a case where the coupling part CA is damaged,), the load of the electric motor MA substantially does not increase even if the inlet valve VI and the differential pressure valve UA are in a fully closed state. Therefore, in the determination mode drive, the motor rotation number Na does not decrease (see the characteristic line ZIc indicated by the broken line). Since a state in which the motor rotation number Na is larger than the determination rotation number nx is continued and the third determination condition is not satisfied, determination is made at time point s5 that the coupling part CA is abnormal. Also in the third processing example, similarly to the first and second processing examples, the determination mode drive is terminated at the end time point s5 of the determination period. Furthermore, the determination mode drive may be terminated at time point s4 when the third determination condition is satisfied.

Operation of [Mode 3b]

The above [mode 3b] will be described with reference to FIG. 5B. The difference from [mode 3a] is that “the power supply to the differential pressure valve UA is gradually performed” and “the inlet valve VI is not closed” in the determination mode drive. Hereinafter, the differences will be mainly described.

At time point s6, the determination mode drive is started, and the electric motor MA is driven in the forward rotation direction. Specifically, the electric motor MA is driven in a steady state of “Na=na”. At time point s7, the differential pressure valve UA is driven in the determination mode. In [mode 3b], no power is supplied to the inlet valve VI, and the inlet valve VI remains opened. From time point s7, the differential pressure valve current Ia is gradually increased in an increasing gradient da. When the differential pressure valve current Ia reaches the predetermined current ig, the differential pressure valve current Ia is thereafter maintained at the predetermined current ig. As described above, the increasing gradient da (the change amount in the differential pressure valve current Ia with respect to time) and the predetermined current ig are predetermined values (constants) set in advance. At time point s7, counting of the time T related to the determination time th is started. In [mode 3b], the rotation number determination period is from time point s7 to time point s10.

At a normal time of the coupling part CA, when the differential pressure valve current Ia exceeds the valve closing current ic, the differential pressure valve UA enters the fully closed state. As a result, the load of the electric motor MA increases, and the motor rotation number Na decreases. At time point s8, it is satisfied for the first time that the motor rotation number Na is less than or equal to the determination rotation number nx. Then, at time point s9, the state of “Na≤nx” is continued over the duration tj (see the characteristic line ZSi indicated by the solid line). Accordingly, since the third determination condition is satisfied at time point s9, it is determined that the coupling part CA is normal. At an abnormal time of the coupling part CA, the load of the electric motor MA does not increase even if the differential pressure valve UA is closed, and thus the motor rotation number Na does not decrease (see the characteristic line ZIi indicated by the broken line). Since a state in which the motor rotation number Na is larger than the determination rotation number nx is continued and the third determination condition is not satisfied, it is determined at time point s10 that the coupling part CA is abnormal. In [mode 3b] as well, the determination mode drive is terminated at the end time point s10 of the determination period. Furthermore, the determination mode drive may be terminated at time point s9 when the third determination condition is satisfied.

### Fourth Processing Example of Appropriateness Determination

Details of a fourth processing example related to the appropriateness determination will be described.

In the first to third determination examples, the appropriateness determination is executed based on the change in the motor state quantity Ma when the valve opening amount of the differential pressure valve UA is reduced in a state where the electric motor MA is steadily driven in the forward rotation direction. On the contrary, in the fourth processing example, the electric motor MA is driven in the forward rotation direction after power is supplied to the differential pressure valve UA and the inlet valve VI. At this time, both the differential pressure valve UA and the inlet valve VI are brought into a completely closed state.

In the first to third processing examples, the normal state of the coupling part CA is determined based on the change in the motor state quantity Ma. Then, when the normal state is not determined within the determination period, the abnormal state of the coupling part CA is determined. Conversely, in the fourth processing example, the abnormal state of the coupling part CA is determined based on the change in the motor state quantity Ma. Then, when the abnormal state is not determined within the determination period, the normal state of the coupling part CA is determined.

In the fourth processing example, the determination period is set as “from the time point at which the electric motor MA is driven in the forward rotation direction until the determination time tm elapses”. The determination time tm is a predetermined value (constant) set in advance. The determination period according to the fourth processing example is also referred to as a “rotation angle determination period” in order to be distinguished from other determination periods.

A rotation direction of the fluid pump QA and the electric motor MA will be described. The reflux path HK is provided with a check valve GA. Therefore, the fluid pump QA can rotate only in one direction, but rotation in the other direction (the direction opposite to the one direction) is inhibited by the check valve GA. In other words, one direction of the fluid pump QA is a direction in which the fluid pump QA can discharge the braking liquid BF, and the other direction of the fluid pump QA is a direction in which the fluid pump QA cannot discharge the braking liquid BF. In the rotation direction of the electric motor MA, the forward rotation direction corresponds to one direction of the fluid pump QA, and the reverse rotation direction corresponds to the other direction of the fluid pump QA.

In the fourth processing example, the motor rotation angle Ka (angular displacement from zero point) is adopted as the motor state quantity Ma for appropriateness determination. In the fourth processing example, the determination condition is that “the state in which the motor rotation angle Ka has changed to greater than or equal to the determination angle kx with respect to the state before the determination period (i.e., a state before the electric motor MA is driven in the forward rotation direction) is continued over the duration tk”. The determination angle kx and the duration tk are predetermined values (constants) set in advance. The duration tk is provided to eliminate the influence of noise or the like. The determination condition according to the fourth processing example is also referred to as a “fourth determination condition” in order to be distinguished from other determination conditions. When the fourth determination condition is satisfied, the abnormal state of the coupling part CA is determined. That is, the fourth determination condition is a condition for determining the abnormal state of the coupling part CA.

As described above, when the differential pressure valve UA and the inlet valve VI are completely closed, the electric motor MA and the fluid pump QA cannot substantially rotate if the coupling part CA is normal. On the other hand, when the motor rotation angle Ka increases from the state before the determination period, the electric motor MA idles or the backlash (play) of the coupling part CA increases. Therefore, when the fourth determination condition is satisfied, the abnormal state of the coupling part CA is determined. When the abnormality of the coupling part CA is determined, the notification signal Wg is output to the notification device WG, and notification to the driver is performed.

In the power transmission in the coupling part CA, at least one of the motor end plane Mm and the pump end plane Mq may wear, and backlash (gap between members) between the motor end plane and the pump end plane may increase with time. The motor rotation angle Ka when both the differential pressure valve UA and the inlet valve VI are closed corresponds to the backlash of the coupling part CA. In the fourth processing example, since the motor rotation angle Ka is adopted as the motor state quantity Ma, an increase in backlash in the coupling part CA can be determined.

### Modified Example of Fourth Processing Example

In the above determination example, the motor rotation angle Ka before the start of the determination period is set as zero point serving as the reference of the motor rotation angle Ka. Furthermore, the electric motor MA is preferably driven once in the reverse rotation direction before the determination mode drive so that the backlash of the coupling part CA can be more accurately detected.

Since the check valve GA inhibits the fluid pump QA from rotating in the other direction, when driven in the reverse rotation direction of the electric motor MA, a gap (backlash) between the motor end plane Mm and the pump end plane Mq is eliminated in the reverse rotation direction. The reverse rotation drive of the electric motor MA before the determination period is called “backlash elimination drive”.

In the modified example, first, the backlash elimination of the coupling part CA is performed by the backlash elimination drive, and the rotation angle Ka generated at that time is set as the zero point (0) related to the change. Then, in the rotation angle determination period, the appropriateness determination is executed based on the motor rotation angle Ka generated in the forward rotation direction from the zero point (0). Specifically, the abnormal state of the coupling part CA is determined when the motor rotation angle Ka (angular displacement from the zero point) is greater than or equal to a predetermined angle kx with reference to the zero point (0) set by the backlash elimination drive. In the modified example, since the backlash elimination of the coupling part CA is performed prior to the determination period, the accuracy of the abnormality determination of the coupling part CA can be more accurately improved.

### Operation of Fourth Processing Example

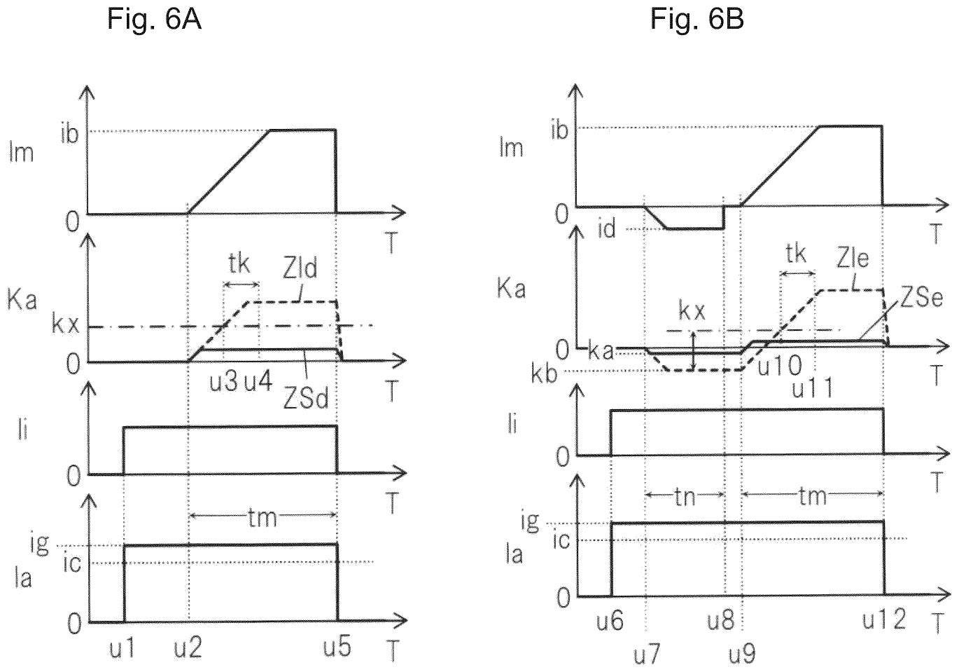

The operation of the fourth processing example related to the appropriateness determination of the coupling part CA will be described with reference to the time-series diagrams in FIGS. 6A and 6B are. In FIGS. 6A and 6B, a situation in which backlash in the coupling part CA is increased is assumed as the abnormality of the coupling part CA.

A determination method in which the electric motor MA is driven only in the forward rotation direction will be described with reference to FIG. 6A. At time point u1, the inlet valve VI and the differential pressure valve UA are driven in the determination mode. Specifically, the supply current Ii (inlet valve current) to the inlet valve VI is increased, and the inlet valve VI is completely closed. In addition, the supply current Ia (differential pressure valve current) to the differential pressure valve UA is increased to the value ig (>ic), and the differential pressure valve UA is also completely closed.

At time point u2, the determination period is started, and the electric motor MA is driven in the forward rotation direction. Specifically, the supply current Im to the electric motor MA is gradually increased to a predetermined current ib. The predetermined current ib is a predetermined value (constant) set in advance corresponding to the forward rotation direction of the electric motor MA. Note that in FIGS. 6 and 6B, the display of the inrush current of the electric motor MA is omitted.

When the backlash of the coupling part CA is increased (i.e., when the coupling part CA is abnormal), the motor rotation angle Ka increases from the zero point (0) as the motor current Im increases from time point u2 (see the characteristic line ZId indicated by the broken line). Here, the motor rotation angle Ka before the start of the determination period is adopted as the zero point (0) to be a reference of the motor rotation angle Ka. At time point u3, the motor rotation angle Ka (i.e., the change amount in the motor rotation angle Ka from the zero point) based on the zero point (0) is greater than or equal to the determination angle kx. From time point u3, time counting of the state of “Ka≥kx” is started. At time point u4, the maintaining time of the state of “Ka≥kx” reaches the duration tk. That is, the state in which the motor rotation angle Ka changes to greater than or equal to the determination angle kx with respect to the state before the electric motor MA is driven in the forward rotation direction is continued over the duration tk (predetermined value set in advance). Since the fourth determination condition is satisfied, the abnormality of the coupling part CA is determined at time point u4.

When the coupling part CA is normal, the backlash is slight, and thus, the motor rotation angle Ka is not increased or is slightly increased from the state before the determination period (i.e., the state before time point u2) (see the characteristic line ZSd indicated by the solid line). Therefore, the fourth determination condition is not satisfied within the determination period (between time point u2 and time point u5). At time point u5, determination is made that the coupling part CA is normal. In the fourth determination example as well, when the determination period ends, the determination mode drive ends. Furthermore, the determination mode drive may be terminated at time point u4 when the fourth determination condition is satisfied.

### Modified Example

FIG. 6B illustrates a case where the electric motor MA is driven in the forward rotation direction after being once driven in the reverse rotation direction (direction opposite to the forward rotation direction) as a modification of the fourth processing example. In FIG. 6B, a period from time point u7 to time point u8 is a period for backlash elimination drive, and a period from time point u9 to time point u12 is a determination period.

Also in the modified example, first, the inlet valve VI and the differential pressure valve UA are closed at time point u6. Thereafter, at time point u7, the backlash elimination drive is started, and the electric motor MA is driven in the reverse rotation direction. Specifically, the supply current Im to the electric motor MA is gradually increased to the predetermined current id (considering the negative sign of the motor current Im, gradually reduced to the predetermined current id). The predetermined current id is a predetermined value (constant) set in advance corresponding to the reverse rotation direction of the electric motor MA. The backlash elimination drive is continued for a predetermined time tn. The predetermined time tn is a predetermined value (constant) set in advance. The backlash elimination drive eliminates a gap between the motor end plane Mm and the pump end plane Mq.

The motor rotation angle Ka generated by the backlash elimination drive is determined as a zero point (0) serving as a reference. For example, when the backlash is small, the zero point (0) has the value ka. On the other hand, when the backlash is large, the zero point (0) has the value kb. At time point u8, the backlash elimination drive is terminated, and the motor current Im is set to “0”.

From time point u9, the motor current Im is gradually increased to the predetermined current ib. As a result, the electric motor MA is driven in the forward rotation direction, and the motor rotation angle Ka gradually increases. A time point u9 at which the forward rotation drive of the electric motor MA is started is set as a start point of the rotation angle determination period. From time point u9, the time count related to the determination time tm is started. In the determination period, the appropriateness is determined based on the motor rotation angle Ka with the motor rotation angle Ka before the determination period as a reference (zero point).

When the backlash of the coupling part CA increases (i.e., when the coupling part CA is abnormal,), the motor rotation angle Ka increases from the zero point (the position of the value kb) as the motor current Im increases (see the characteristic line ZIe indicated by the broken line). At time point u10, the motor rotation angle Ka (i.e., the change amount in the motor rotation angle Ka from the zero point) based on the zero point (value kb) is greater than or equal to the determination angle kx. From time point u10, time counting of the state of “Ka≥kx” is started. At time point u11, a time during which the state of “Ka≥kx” continues reaches the duration tk. That is, the state in which the motor rotation angle Ka changes to greater than or equal to the determination angle kx with respect to the state before the electric motor MA is driven in the forward rotation direction is continued over the duration tk (predetermined value set in advance). Since the fourth determination condition is satisfied, the abnormality of the coupling part CA is determined at time point u11.

When the coupling part CA is normal, backlash is slight. Therefore, the motor rotation angle Ka does not increase or slightly increases (see the characteristic line ZSe indicated by the solid line) from the zero point (the position of the value ka). Therefore, the fourth determination condition is not satisfied within the determination period (between time point u9 to time point u12). At time point u12, determination is made that the coupling part CA is normal. In the fourth determination example as well, when the determination period ends, the determination mode drive ends. Furthermore, the determination mode drive may be terminated at time point u11 when the fourth determination condition is satisfied.

In the modified example, before the determination period, backlash elimination by the reverse rotation drive of the electric motor MA is executed. Thereafter, the electric motor

MA is forward rotation driven, and the determination period is started. In the determination period, the zero point (0) of the motor rotation angle Ka set by the backlash elimination drive is set as a reference, and a change in the motor rotation angle Ka is monitored. Since the zero point (0) of the motor rotation angle Ka is determined by the backlash elimination drive of the electric motor MA, the abnormal state caused by the backlash of the coupling part CA can be more accurately determined.

In the operation example described above, the electromagnetic valves UA and VI are closed at time point u6 before the backlash elimination period, but these valves may be closed before the start time point u9 of the determination period. That is, the order may be “close electromagnetic valves UA, VI”→“backlash elimination drive”→“determination period”, or the order may be “backlash elimination drive”→“close electromagnetic valves UA, VI”→“determination period”. This is because the drive of the electric motor MA in the reverse rotation direction (corresponding to the other direction of the fluid pump QA) is inhibited by the check valve GA.

### Second Embodiment of Braking Control Device SC

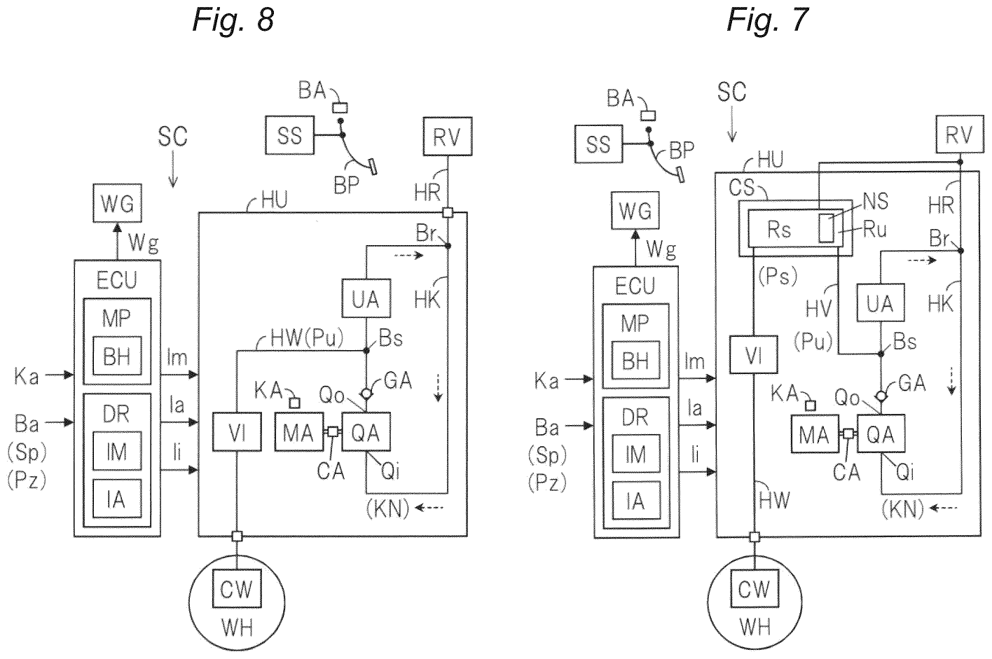

A second embodiment of a braking control device SC will be described with reference to the schematic view of FIG. 7. FIG. 7 schematically illustrates a configuration described in JP 2019-059294 A (in particular, the pressure adjusting unit YC of the upper fluid unit YU and one wheel from the master cylinder CM to the front wheel cylinder CWi) as the fluid unit HU configuring the braking control device SC.

A vehicle to which the second embodiment of the braking control device SC is applied is provided with a braking operation amount sensor BA that detects an operation amount Ba (referred to as a “braking operation amount”) of the braking operation member BP. For example, an operation displacement sensor SP that detects the operation displacement Sp of the braking operation member BP is provided as the braking operation amount sensor BA. In addition, a simulator pressure sensor PZ that detects the liquid pressure Pz (referred to as “simulator pressure”) of the stroke simulator SS is adopted. In the braking control device SC, the braking operation amount Ba is a generic name of a signal representing a braking intention of the driver, and the braking operation amount sensor BA is a generic name of a sensor that detects the braking operation amount Ba. The brake operation amount Ba is input to a controller ECU.

The braking control device SC is provided with a stroke simulator SS (also simply referred to as a “simulator”). The operation force Fp of the braking operation member BP is generated by the simulator SS. Since the braking control device SC is a brake-by-wire type, the operation characteristic (the relationship between the operation displacement Sp and the operation force Fp) of the braking operation member BP is generated by the simulator SS. A simulator pressure sensor PZ is provided to detect the simulator pressure Pz. Note that the simulator pressure Pz is a state quantity representing the operation force Fp of the braking operation member BP.

The fluid unit HU according to the first embodiment is a general-purpose unit for performing sideslip prevention and the like. On the other hand, a second embodiment of the braking control device SC is a brake-by-wire type service brake device. The braking control device SC includes the fluid unit HU and the controller ECU.

The fluid unit HU according to the second embodiment is a unit for a service brake (also referred to as a “service brake”). The wheel pressure Pw of the wheel cylinder CW is adjusted according to the braking operation amount Ba by the fluid unit HU. Specifically, the wheel pressure Pw is controlled to increase as the braking operation amount Ba increases. Similarly to the first embodiment, in the second embodiment, the fluid unit HU includes the electric motor MA, the fluid pump QA, the differential pressure valve UA, and the inlet valve VI.

The difference from the first embodiment is that “the fluid pump QA can suck the braking liquid BF from the master reservoir RV (also referred to as “atmospheric pressure reservoir”)” and “the liquid pressure Pu (referred to as “servo pressure”) adjusted by the differential pressure valve UA is transmitted as the wheel pressure Pw to the wheel cylinder CW via the control cylinder CS and the control piston NS” in the second embodiment. Specifically, in the second embodiment, the liquid pressure is transmitted in the order of “Pu→Ps→Pw”. As described above, since the components denoted by the same reference numerals as those in the first embodiment have the same functions, differences will be mainly described.

The electric motor MA and the fluid pump QA are connected by way of a coupling part CA. The power of the electric motor MA is transmitted to the fluid pump QA via the coupling part CA. The electric motor MA is provided with a rotation angle sensor KA so as to detect the rotation angle Ka of the rotor (rotor). Then, in the controller ECU, the motor rotation number Na is calculated based on the motor rotation angle Ka.

In the fluid pump QA, the intake part Qi and the discharge part Qo are connected by a reflux path HK. The reflux path HK is provided with a differential pressure valve UA which is a normally-open linear electromagnetic valve. A check valve GA is provided in the vicinity of the discharge part Qo of the reflux path HK. The reflux path HK is connected to the master reservoir RV via the reservoir path HR (fluid path) at a portion Br (portion between the differential pressure valve UA and the intake part Qi) on the upstream side of the intake part Qi on the downstream side of the differential pressure valve UA. In addition, the reflux path HK is connected to the servo chamber Ru of the control cylinder CS via the servo path HV (fluid path) at a portion Bs (portion between the fluid pump QA and the differential pressure valve UA) on the upstream side of the differential pressure valve UA on the downstream side of the check valve GA.

A control piston NS is inserted into the control cylinder CS. The inside of the control cylinder CS is partitioned into two liquid pressure chambers (referred to as “servo chamber Ru” and “control chamber Rs”) by the control piston NS. The servo chamber Ru is connected to the servo path HV. Furthermore, the control chamber Rs is connected to the wheel cylinder CW via the wheel path HW. The wheel path HW (corresponding to a “liquid pressure transmission path from the output pressure Pu to the wheel pressure Pw”) is provided with an inlet valve VI which is a normally-open type on/off electromagnetic valve.

When the braking operation amount Ba is “0 (zero)” (i.e., at the time of non-braking), the fluid unit HU is not driven. Therefore, power is not supplied to the differential pressure valve UA, the electric motor MA, and the inlet valve VI. At the time of braking, the electric motor MA is driven, and a circulation flow KN of “Qo→GA→UA→Qi” is generated in the reflux path HK as indicated by a broken arrow. When power is not supplied to the differential pressure valve UA and the differential pressure valve UA is in a fully opened state, the liquid pressure Pu (servo pressure corresponding to “output pressure”) on the upstream side and the liquid pressure (atmospheric pressure) on the downstream side are equal to each other (i.e., “Pu=0”) with respect to the differential pressure valve UA in the reflux path HK.

When the energization amount Ia (supply current) to the differential pressure valve UA is increased according to the increase in the braking operation amount Ba, the valve opening amount of the differential pressure valve UA is reduced. As a result, the circulation flow KN (the flow of the braking liquid BF circulating in the reflux path HK) is throttled by the differential pressure valve UA, and the flow of the circulation flow KN is inhibited. As a result, the liquid pressure Pu (servo pressure) on the upstream side of the differential pressure valve UA is increased from the atmospheric pressure.

The servo pressure Pu is supplied to the servo chamber Ru via the servo path HV. As the servo pressure Pu increases, the control piston NS is pressed in the forward direction (direction in which volume of servo chamber Ru increases and volume of control chamber Rs decreases). As a result, the liquid pressure Ps (referred to as “control pressure”) in the control chamber Rs is increased. Since the control chamber Rs is connected to the wheel cylinder CW via the wheel path HW, the control chamber Rs is supplied to the wheel cylinder CW as the wheel pressure Pw. At the time of braking (in the case of service brake at the time of non-execution such as anti-lock brake control), power supply to the inlet valve VI is not performed, and the inlet valve VI is in a fully opened state.

In the fluid unit HU according to the second embodiment, the servo pressure Pu is generated by throttling the circulation flow KN of the braking liquid BF discharged from the fluid pump QA by the differential pressure valve UA. The servo pressure Pu is supplied to the servo chamber Ru in the control cylinder CS. The servo pressure Pu is transmitted as the control pressure Ps through the control piston NS. Then, the control pressure Ps is supplied to the wheel cylinder CW as the wheel pressure Pw via the wheel path HW.

The fluid unit HU is controlled by the controller ECU. The braking operation amount Ba (Sp, Pz, etc.) and the motor rotation angle Ka are input to the controller ECU. In the controller ECU, the service brake control is executed based on the signal of the braking operation amount Ba. The “service brake control” is control of the wheel pressure Pw according to the braking operation amount Ba in order to realize the function of the service brake. Specifically, the electric motor MA is driven by the controller ECU, and the circulation flow KN is generated in the reflux path HK. The differential pressure valve current Ia is adjusted so as to increase as the braking operation amount Ba increases. Accordingly, in the service brake control, the servo pressure Pu (as a result, the wheel pressure Pw) is controlled to increase as the braking operation amount Ba increases. In the controller ECU, the appropriateness determination of the coupling part CA is executed in the same manner as described above.

### Third Embodiment Of Braking Control Device SC

A third embodiment of a braking control device SC will be described with reference to the schematic view of FIG. 8. FIG. 8 schematically illustrates a configuration (In particular, one wheel from the pressure adjusting unit YC of the upper fluid unit YU to the wheel cylinder CWk of the rear wheel) described in JP 2019-059294 A as the fluid unit HU constituting the braking control device SC.

Similarly to the second embodiment, the braking control device SC according to the third embodiment is a brake-by-wire type unit for service brake. The difference therebetween is that the servo pressure Pu is transmitted to the wheel cylinder CW via the control cylinder CS and the control piston NS in the second embodiment, whereas the servo pressure Pu is directly transmitted to the wheel cylinder CW in the third embodiment. Specifically, in the third embodiment, the reflux path HK is connected to the wheel cylinder CW via the wheel path HW at a portion Bs (a portion between the fluid pump QA and the differential pressure valve UA) on the upstream side of the differential pressure valve UA on the downstream side of the check valve GA. As a result, the servo pressure Pu is directly supplied to the wheel cylinder CW as the wheel pressure Pw. In the third embodiment as well, similarly to the above, in the controller ECU, the appropriateness determination of the coupling part CA is executed.

### Summary of Embodiments

Hereinafter, embodiments of the braking control device SC will be summarized.

The braking control device SC includes an electric motor MA, a fluid pump QA, a differential pressure valve UA, an inlet valve VI, and a controller ECU. The electric motor MA and the fluid pump QA are coupled (joined) by a coupling part CA. The power of the electric motor MA is transmitted to the fluid pump QA via the coupling part CA, whereby the fluid pump QA is driven. A fluid path HK (reflux path) is provided to connect the discharge part Qo of the fluid pump A and the intake part Qi of the fluid pump QA.

A check valve GA is provided in the fluid path HK. The check valve GA allows the fluid pump QA to rotate in one direction but cannot rotate in the other direction (the direction opposite to the one direction). In the rotation direction, one direction of the fluid pump QA corresponds to the forward rotation direction of the electric motor MA, and the other direction of the fluid pump QA corresponds to the reverse rotation direction of the electric motor MA. Therefore, when the coupling part CA is normal, the check valve GA allows the electric motor MA to rotate in the forward rotation direction, but does not allow the electric motor MA to rotate in the reverse rotation direction opposite to the forward rotation direction.

A differential pressure valve UA is provided in the fluid path HK. For example, the differential pressure valve UA is a normally-open linear electromagnetic valve. The differential pressure valve UA increases the braking liquid BF discharged from the fluid pump QA to the output pressures Pq and Pu. Specifically, in the first embodiment, the adjustment pressure Pq corresponds to the output pressure, and the master pressure Pm is increased to the adjustment pressure Pq. In the second and third embodiments, the servo pressure Pu corresponds to the output pressure, and the atmospheric pressure is increased to the servo pressure Pu. Then, the wheel pressure Pw of the wheel cylinder CW is increased by the output pressures Pq and Pu.

An inlet valve VI (e.g., a normally-open type on/off electromagnetic valve) is provided in a liquid pressure transmission path (HW or the like) from the output pressures Pq and Pu to the wheel pressure Pw. Specifically, in the first embodiment, the liquid pressure transmission path corresponds to the wheel path HW connecting the portion Bw between the differential pressure valve UA and the fluid pump QA and the wheel cylinder CW. In the second embodiment, the liquid pressure transmission path corresponds to the wheel path HW connecting the control chamber Rs of the control cylinder CS and the wheel cylinder CW. In the third embodiment, the liquid pressure transmission path corresponds to the wheel path HW connecting the portion Bs between the differential pressure valve UA and the fluid pump QA and the wheel cylinder CW. That is, the liquid pressure transmission path corresponds to the wheel path HW connected to the wheel cylinder CW. The electric motor MA, the differential pressure valve UA, and the inlet valve VI are driven by the controller ECU.

The controller ECU includes an appropriateness determination block BH so as to perform appropriateness determination as to whether the coupling part CA is normal or abnormal. The appropriateness determination in the controller ECU (i.e., the appropriateness determination block BH) is executed when the vehicle is stopped (i.e., in the case of “Vx=0”). For example, the appropriateness determination is executed as an initial check of the braking control device SC when the ignition switch is turned on. Alternatively, the operation may be executed when a door of the vehicle is opened for the driver to get on the vehicle (e.g., in a case where the courtesy switch is turned on). Furthermore, the appropriateness determination may be performed before execution of automatic traveling including automatic parking control such as remote parking control.

When reducing the valve opening amount of the differential pressure valve UA in the state of driving the electric motor MA, the controller ECU performs the appropriateness determination on whether the coupling part CA is normal based on the change in the state quantity Ma (motor state quantity) related to the electric motor MA. Specifically, when the driving of the electric motor MA is maintained in a constant state (i.e., a steady state), the valve opening amount of the differential pressure valve UA is reduced. The normality of the coupling part CA is determined based on the change in the motor state quantity Ma at that time. When the normality of the coupling part CA is not determined, the abnormality of the coupling part CA is determined.

The controller ECU (in particular, a first processing example) executes the appropriateness determination based on the change (increase) in the output equivalent value Tm corresponding to the output of the electric motor MA when reducing the valve opening amount of the differential pressure valve UA in the state (i.e., in a steady driving state) in which the rotation number Na of the electric motor MA is controlled to be the constant rotation number na. Specifically, when the output equivalent value Im is greater than or equal to the determination threshold value ix, the coupling part CA is determined to be normal. On the other hand, when the coupling part CA is not determined to be normal, the coupling part CA is determined to be abnormal. The determination threshold value ix is a determination threshold value corresponding to the output equivalent value Tm, and is a predetermined value (constant) set in advance. When the valve opening amount of the differential pressure valve UA is reduced in the normal state of the coupling part CA, the load of the electric motor MA increases. In the electric motor MA, the motor rotation number Na is controlled to be constant at the predetermined rotation number na, and thus the motor current Im is increased so that the output equivalent value Im increases according to the increase in the load. Therefore, when the output equivalent value Tm increases to greater than or equal to the determination threshold value ix, the normal state of the coupling part CA is determined.

When the controller ECU (in particular, a second processing example) supplies the constant current im to the electric motor MA to reduce the valve opening amount of the differential pressure valve UA while the electric motor MA is driven (i.e., in a steady driving state), the controller ECU executes the appropriateness determination based on the change (decrease) in the rotation number Na of the electric motor MA. Specifically, it is determined that the coupling part CA is normal when the motor rotation number Na is less than or equal to the determination rotation number nx. On the other hand, when the coupling part CA is not determined to be normal, the coupling part CA is determined to be abnormal. The determination rotation number nx is a threshold value for determination corresponding to the motor rotation number Na, and is a predetermined value (constant) set in advance. When the valve opening amount of the differential pressure valve UA is reduced in the normal state of the coupling part CA, the load of the electric motor MA increases. Since the motor current Im supplied to the electric motor MA is the constant value im, the motor rotation number Na decreases as the load increases. Therefore, when the motor rotation number Na decreases to less than or equal to the determination rotation number nx, the normal state of the coupling part CA is determined.

When the differential pressure valve UA is completely closed in a state where the electric motor MA is driven, the controller ECU (in particular, a third processing example) executes the appropriateness determination based on the change (decrease) in the rotation number Na of the electric motor MA. Specifically, it is determined that the coupling part CA is normal when the motor rotation number Na is less than or equal to the determination rotation number nx. On the other hand, when the coupling part CA is not determined to be normal, the coupling part CA is determined to be abnormal. The determination rotation number nx is a threshold value for determination corresponding to the motor rotation number Na, and is a predetermined value (constant) set in advance. When the differential pressure valve UA is fully closed in the normal state of the coupling part CA, the load of the electric motor MA increases and the motor rotation number Na decreases. Therefore, when the motor rotation number Na decreases to less than or equal to the determination rotation number nx, the normal state of the coupling part CA is determined.

When the electric motor MA is driven in the forward rotation direction in a state where the inlet valve VI and the differential pressure valve UA are closed, the controller ECU (in particular, a fourth processing example) executes the appropriateness determination based on the increase (specifically, the increase in the forward rotation direction) in the rotation angle Ka of the electric motor MA. Specifically, it is determined that the coupling part CA is abnormal when the motor rotation angle Ka changes to greater than or equal to the determination angle kx with respect to the state before the electric motor MA is driven in the forward rotation direction. On the other hand, when the coupling part CA is not determined to be abnormal, the coupling part CA is determined to be normal. The determination angle kx is a threshold value for determination corresponding to the motor rotation angle Ka, and is a predetermined value (constant) set in advance. When the differential pressure valve UA and the inlet valve VI are brought into the fully closed state in the normal state of the coupling part CA, the electric motor MA is brought into a substantially non-rotatable state. Therefore, when the motor rotation angle Ka increases to greater than or equal to the determination angle kx, the abnormal state of the coupling part CA is determined. Note that before the electric motor MA is driven in the forward rotation direction, the electric motor MA is preferably driven in the reverse rotation direction opposite to the forward rotation direction. The backlash elimination of the coupling part CA is performed by the reverse rotation drive of the electric motor MA, and the determination accuracy can be improved.

1. A braking control device for vehicles comprising:
a fluid pump driven by an electric motor via a coupling part;
a differential pressure valve provided in a fluid path connecting a discharge part of the fluid pump and an intake part of the fluid pump, the differential pressure valve increasing a wheel pressure of a wheel cylinder by increasing a braking liquid discharged from the fluid pump to an output pressure; and
a controller that drives the electric motor and the differential pressure valve; wherein
when a valve opening amount of the differential pressure valve is reduced in a state in which the electric motor is driven, the controller performs an appropriateness determination as to whether or not the coupling part is normal based on a change in a state quantity related to the electric motor.

2. A braking control device for vehicles comprising:
a fluid pump driven by an electric motor via a coupling part;
a differential pressure valve provided in a fluid path connecting a discharge part of the fluid pump and an intake part of the fluid pump, the differential pressure valve increasing a wheel pressure of a wheel cylinder by increasing a braking liquid discharged from the fluid pump to an output pressure; wherein a controller that drives the electric motor and the differential pressure valve; wherein
when a valve opening amount of the differential pressure valve is reduced in a state in which a rotation number of the electric motor is controlled to be a constant rotation number, the controller performs an appropriateness determination as to whether or not the coupling part is normal based on an increase in an output equivalent value equivalent to an output of the electric motor.

3. The braking control device for vehicles according to claim 2, wherein
the controller determines that the coupling part is normal when the output equivalent value is greater than or equal to a determination threshold value.

4. A braking control device for vehicles comprising:
a fluid pump driven by an electric motor via a coupling part;
a differential pressure valve provided in a fluid path connecting a discharge part of the fluid pump and an intake part of the fluid pump, the differential pressure valve increasing a wheel pressure of a wheel cylinder by increasing a braking liquid discharged from the fluid pump to an output pressure; and
a controller that drives the electric motor and the differential pressure valve; wherein
when a valve opening amount of the differential pressure valve is reduced in a state in which a constant current is supplied to the electric motor, the controller performs an appropriateness determination as to whether or not the coupling part is normal based on a decrease in rotation number of the electric motor.

5. (canceled)

6. (canceled)

7. (canceled)

8. (canceled)

9. (canceled)

10. The braking control device for vehicles according to claim 4, wherein
the controller determines that the coupling part is normal when the rotation number is less than or equal to a determination rotation number.
